(19) United States
(12) Patent Application Publication
(10) Pub. No.: US 2012/0109875 A1
(43) Pub. Date: May 3, 2012

(54) ORGANIZATION OF DATA MART USING CLUSTERED KEY

(75) Inventors: Giri Sundaram, Issaquah, WA (US); Akshaya Arora, Bothell, WA (US); Dana Pepper, Federal Way, WA (US)

(73) Assignee: MICROSOFT CORPORATION, Redmond, WA (US)

(21) Appl. No.: 12/916,562

(22) Filed: Oct. 31, 2010

(51) Int. Cl. G06F 17/00

(52) U.S. Cl. 707/600; 707/E17.044

(57) ABSTRACT

A data mart may be organized using a clustered key, thereby allowing certain efficiencies in data search and retrieval to be realized. In one example, the clustered key is made of a plurality of attributes. The attributes may be chosen based on their likelihood of being using as search criteria. The likelihood of a given attribute being used as a search criterion may be determined through historical analysis of search requests. Records in the data mart may be sorted based on the attributes in the clustered key, thereby producing records that are organized by attribute in sequential runs. When a search uses an attribute in the clustered key as a search criterion, the records that are being sought may appear in one or more sequential runs, thereby leveraging the efficiency of sequential reads as opposed to random reads.

### BACKGROUND

A data mart is a data store that has been organized to service certain types of requests. An example of a data mart is a collection of data about web advertising events. People, or other entities, that purchase web advertising often like to see data concerning activity relating to their advertising, so they can perform analysis on the data and see how well their advertising efforts are working.

One issue that arises with a data mart is that it may contain huge amounts of data. Thus, servicing a request for a particular slice of that data can take a long time. However, the length of time is often due to the fact that the data is not organized to take advantage of efficiencies in the access system. For example, data might be stored in a relational database and organized by a certain type of primary key. (A “candidate key” is one or more attributes that are sufficient to distinguish any row of a table from any other row; a “primary key” is a candidate key of minimal size.)

However, the attributes that are used in the primary key might have nothing to do with the actual criteria that are being used to query the data mart. Thus, if data is organized by such a primary key, then the organization of the data might fail to take advantage of certain efficiencies that the underlying database system offers. In particular, relational database systems often can access sequential rows of a table more efficiently than they can access random rows, but existing data marts fail to use this efficiency in a way that addresses the kinds of requests that are made of data marts.

### SUMMARY

Data marts may be organized using a clustered key. A data mart may be stored by a relational database, in which data is organized into tables that have rows and columns, with each column having a label called an attribute. The clustered key may be composed of those attributes that are typically used as query criteria when querying the data mart. The clustered key may or may not be a primary or candidate key. The rows that make up a table may be sorted by the attributes that make up the clustered key. Thus, if a clustered key is made up of three attributes, a₁, a₂, and a₃, the rows of a table may be sorted first on attribute a₁, then on attribute a₂, and then on attribute a₃. In this way, if one requests records that fall in a particular range of values on attribute a₁, the records will appear in the table sequentially, thereby allowing a fast sequential retrieval of those records. Even if one requests records on a particular range of values for attribute a₂, the request records are likely to fall into groups of sequential rows. Moreover, the requested data is likely to fall into a small number of data blocks, which simplifies the retrieval process at the physical level.

The clustered key, and the order of the attributes that appear in the key, may be chosen based on the type of data that are stored in the data mart, and based on the way in which those data are typically requested. For example, web advertising data are often requested by date and time. Therefore, the clustered key can use the date/time attribute as its first attribute. Web advertising records may also be requested by account number, but perhaps less frequently than they are requested by date and time. Therefore, the account number can be the second attribute in the clustered key. When the data is sorted by the clustered key, the result is that all rows have the same date/time value are clustered together in sequence. Then, within each sequence of rows that have the same date/time value, rows having the same account number are clustered together.

Organizing rows in this way allows for efficient retrieval, when rows are requested based on attributes in the clustered key. Thus, if one requests rows having a specific date/time value, all rows with that value would, in this example, fall within one sequence, so retrieval of those rows can be performed by reading a single sequence of rows. If one requests rows having a particular account number, the retrieval is slightly more complicated, since there could be as many sequences of rows having the same account number as there are different date/time values. However, since the rows with the same account number appear in a single tight sequence for each value of the date/time attribute, accessing the rows with the same account number is still simpler than if the rows were spread out randomly. Also, inasmuch as the rows are physically organized into data blocks, when the data being sought is tightly clustered into narrow bands of rows, it may be possible to avoid reading certain blocks of data that do not contain the data being sought, thereby creating another efficiency.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which data could be generated for a data mart.

FIG. 2 is a flow diagram of an example process of creating a data mart with clustered data.

FIG. 3 is a block diagram of a plurality of records that have been sorted on an example clustered key.

FIG. 4 is a flow diagram of an example process of retrieving records in response to a request.

FIG. 5 is a block diagram of an example data mart that is stored in several physical blocks.

FIG. 6 is a block diagram of example components that may be used in connection with implementations of the subject matter described herein.

### DETAILED DESCRIPTION

A data mart contains certain types of data. In one example, a data mart contains records of web advertising events. A person or other entity may subscribe to a web advertising service, in order to have advertisements shown to web users. Each ad impression and each click through is recorded as an event. The subscriber may want to retrieve these events in order to analyze the performance of the subscriber's advertising strategy. Or, the advertising service itself may offer this type of analysis as a service to its subscribers, in which case the records of events still have to be retrieved so that the service can analyze them. Thus, a data mart may be created that stores records of the events, so that the event data can be accessed.

The data mart may be stored using a relational database. A relational database stores data in tables. Each table has one or more columns (with each having a column name called an attribute). Each row of the table corresponds to a data record. For a data mart that contains information about web transactions, the columns might have names like date/time, account number, keywords, event type, etc. One feature of a relational database is the ability to retrieve and manipulate rows through a query language, such as Structured Query Language (SQL). SQL allows one to specify particular criteria for retrieving rows (e.g., retrieve all rows for which the date/time attribute falls into the range January 1 through January 15), or to specify particular operations to be performed on the retrieved rows (e.g., sort the retrieved rows on the account-number attribute). While a relational database can execute these types of queries regardless of the organization of the data, executing the query may be inefficient. One issue that arises in applications of relational database is how to organize the table physically for storage, in order to allow for efficient retrieval. Data marts for web advertising data typically contain several terabytes of data, and processing a request on a data mart that is not organized for efficient retrieval may take several hours.

The subject matter described herein allows data to be retrieved efficiently from data marts. The efficiency is derived from observations about how the data in a data mart is commonly requested, and what types of data retrievals can be done efficiently. In general, a database system can perform sequential reads much more quickly than random reads. Thus, retrieval can be done very quickly if the data to be retrieved is located close together.

In order to put the data to be retrieved close together, a clustered key is created for the data. The clustered key is made up of those attributes on which it is expected that the data will be queried. Those attributes appear in the key in order of the frequency with which they are expected to be used. For example, if a data mart contains records of web advertising events, and if the records are often queried based on a particular time range, then the clustered key might have the date/time attribute as its first element. If the records are often queried by account number (but not as often as they are queried by time), then the account number attribute could be second in the clustered key. The choice of the attributes that make up the key, and the order in which they appear in the key, can be informed by a historical analysis of what types of requests are made frequently for records in the data mart. The clustered key may or may not be a primary key or candidate key—i.e., it is possible that the clustered key would not have enough attributes (or the right attributes) to distinguish each record from every other record.

Once the key is chosen, the records may be sorted on that key. Thus, the records are first sorted on the first attribute, thereby creating sequential bands of records that have the same value for the first attribute. Within those sequential bands of records, the records can then be sorted on the second attribute. And so on, for all of the attributes in the key. Thus, the result is a sorted set of records, such that all records that have the same value in the first attribute appear together. Then, within a given value of the first attribute, those records that have the same value in the second attribute appear together. And so on, for all of the attributes in the key.

If a request is made for records having a particular value (or range of values) for one of the attributes in the key, the request can be serviced efficiently. For example, if the first attribute in the key is date/time and a request is for records that have a particular date/time value, then all of those records will appear sequentially, and will physically stored in a number of data blocks that is likely to be relatively small compared with the total number of data blocks used to store the data mart. Accessing sequential records stored in a small number of data blocks is relatively efficient. If the request seeks records having some value for the second attribute, then the records are not likely to be stored sequentially throughout the data mart (unless all records in the data mart have the same value in the first attribute), but the records that are sought will appear in a sequential run for each given value of the first attribute. That is, if there are n different values for the first attribute and a request seeks those records whose second attribute is equal to a value v, then there are no more than n different sequential runs of records having value v in the second attribute. While searching for these n runs is more expensive than searching for the single sequential run of records having some value for the first attribute, it is less expensive than examining every record in the data mart. In this way, sorting on the clustered key achieves efficiency in the retrieval process.

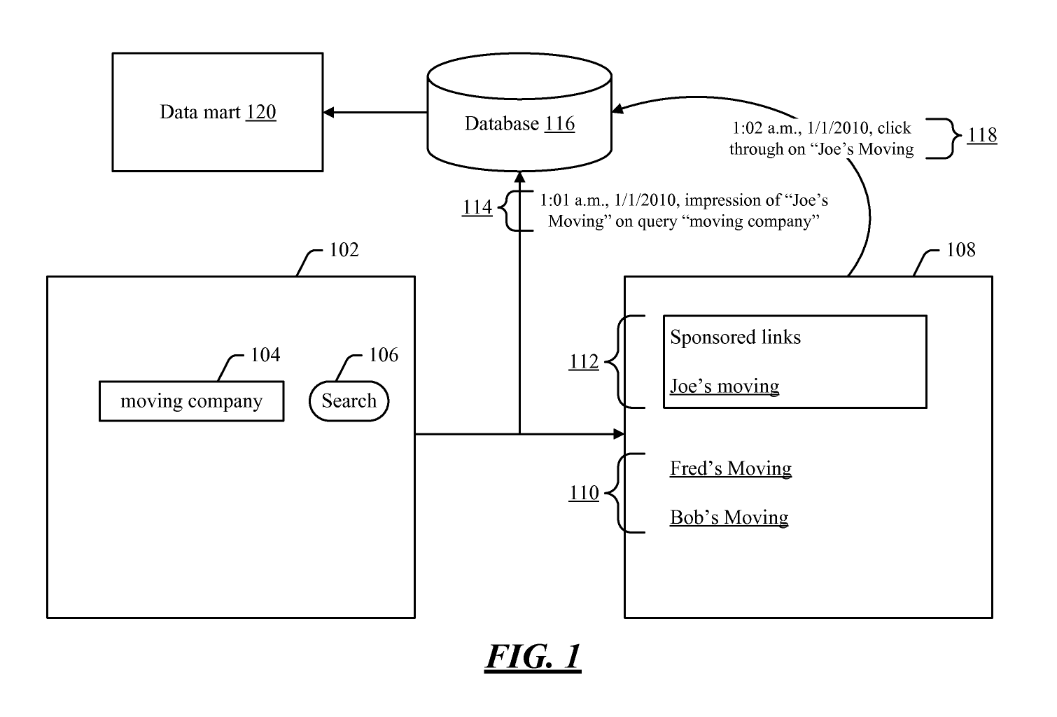

Turning now to the drawings, FIG. 1 shows an example scenario in which data could be generated for a data mart. The example of FIG. 1 shows a scenario in which web advertisements are shown on a web page, such as the web page of a search engine. In this example, a user is first shown web page 102, which invites the user to enter a query. The user enters such a query, in the form of search terms, into search box 104. The example query in this case contains the keywords “moving company”, which might be used to locate assistance in moving one's furniture from one house to another. The user clicks search button 106, thereby activating a search on these keywords.

The search engine provider may monetize its service by selling ads. Thus, when the user clicks button 106, the response from the search engine is web page 108, which contains both algorithmic search results 110 (i.e., those search results that are generated by the search engine's algorithmic attempt to find the closest match between the query and the documents), but also a set of sponsored links 112. The sponsored links 112 are results that are generated from paid subscribers, who have paid to have their ads shown in response to certain keywords (or based on some other criteria). In the field of web advertising, the act of showing a paid ad is referred to as an “impression.” This impression is an event in which a subscriber might be interested. Thus, this event 114 is logged in database 116. The record of the event may show the time at which the event occurred (1:01 a.m. on Jan. 1, 2010); the type of event (“impression”); the query that had been entered when the impression was shown (“moving company”); or any other type of information.

Once the impression has been shown, some users choose to disregard the ad. However, other users choose to click on the ad. When a paid ad is clicked, this event is referred to as a “click through.” The event 118 of the click through may also be recorded in database 116. Database 116 typically contains records showing all activity that occurred during a particular slice of time—e.g., there may be a large record that contains all advertising activity that occurred between 1:00 and 1:59 a.m. on a particular day.

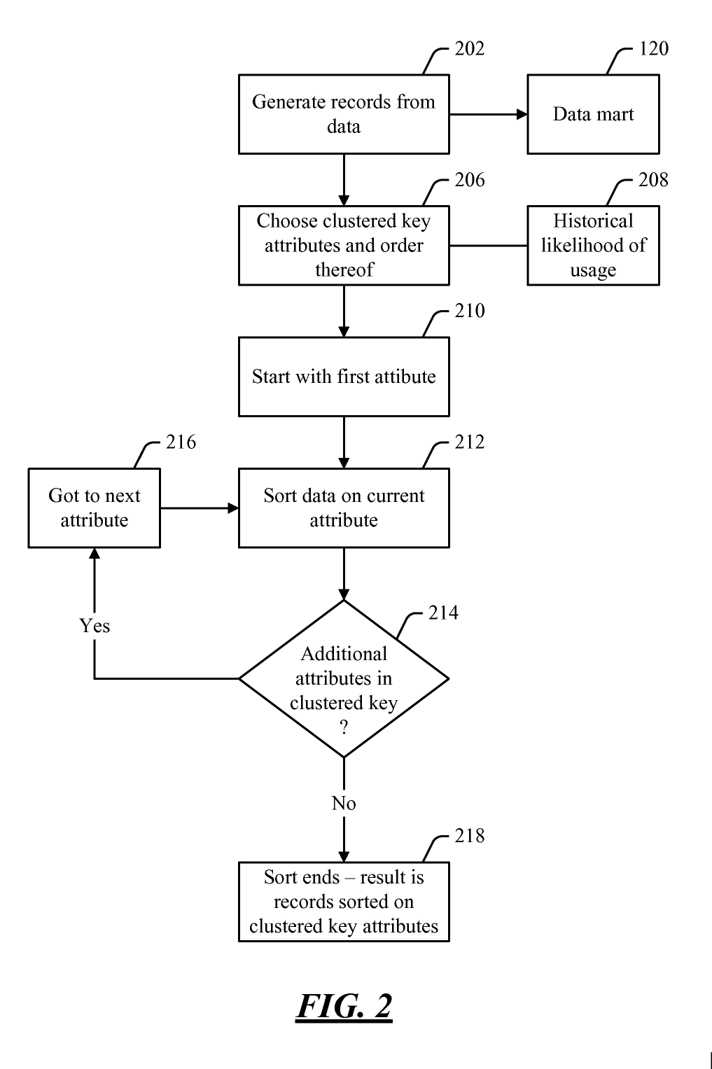

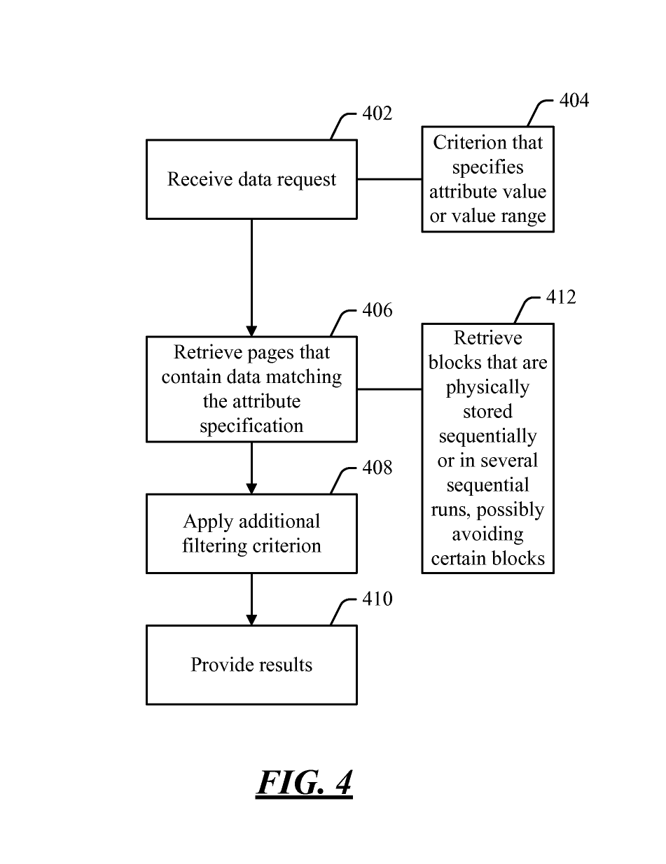

The raw information stored in database 116 may form the basis for a data mart 120. The data mart 120 may, for example, contain individual records for each event. Moreover, as discussed above, these records may be clustered together on the basis of a clustered key. FIG. 2 shows an example process of creating a data mart with clustered data. Before turning to a description of FIG. 2, it is noted that the flow diagrams contained herein (both in FIG. 2 and in FIG. 4) show examples in which stages of a process are carried out in a particular order, as indicated by the lines connecting the blocks, but the various stages shown in these diagrams can be performed in any order, or in any combination or sub-combination.

At 202, records are generated from data. For example, if database 116 (shown in FIG. 1) contains a record for each time slice, and if the record contains all of the events that occur during 1:00-1:59 a.m. on Jan. 1, 2010, then smaller records may be created such that there is one record for each event. Thus, if database 116 contains a single record with one thousand events, the action that takes place at 202 may break this record into one thousand separate records, (although the date/time field might be the same for each of these one thousand records, since the date/time field would simply be copied from the one-hour time slice, “1:00-1:59”, of the larger record from which the individual records are derived). These individual records may be stored as data mart 120.

After the records are generated, a clustered key having a particular set of attributes, and an order of those attributes, is chosen at 206. The clustered key may be chosen in any appropriate manner. However, one way to choose the clustered key is based on the historical likelihood that certain attributes will be used to request data (block 208). In the example in which the data mart contains information about web advertising transactions, it is common to request data based on time. That is one might request all events that occurred on Jan. 1, 2010, or during a particular hour on that day. Thus, the date/time attribute is a likely candidate for inclusion in the clustered key. Moreover, since people tend to request advertising information by date and time more often than they request it on other attributes, it is likely that the date/time attribute would appear first in the order of attributes in the clustered key. This type of information about the kinds of requests that are made, and what sort of attributes are used in those requests, may be determined from an analysis of historical request patterns.

Once the clustered key has been chosen, the records that make up the data mart may be sorted on each of the attributes in the key. To perform this sort, the process starts with the first attribute in the key at 210, thereby making the first attribute the “current” attribute within the terminology of FIG. 2. At 212, the data records are sorted on the current attribute. The result of this sort is one or more groups of data records, which all of the records that have the same value in the first attribute appear sequentially. At 214, it is determined whether there are additional attributes in the key. If so, then the process goes to the next attribute (at 216), thereby making the next attribute in the key the “current” attribute. The process then returns to 212, to sort each of the previously created groups of data records on the current attribute. If there are no additional attributes in the clustered key, then the sort process ends at 218, thereby resulting in a set of records that are sorted on the attributes of the cluster key. The sort that is performed in FIG. 2 is a hierarchical sort, in the sense that the records appear in sort order on the first attribute; then, within each given value of the first attribute, the records appear in sort order on the second attribute; then, within each combination of values of the first and second attribute, the records appear in sort order on the third attribute. And so on, such that the records are sorted on the n-th attribute within each combination of values for attributes that appear prior to the n-th attribute in the clustered key's order. Sorting on a plurality of attributes in this manner may be referred to as “hierarchically sorting” the records.

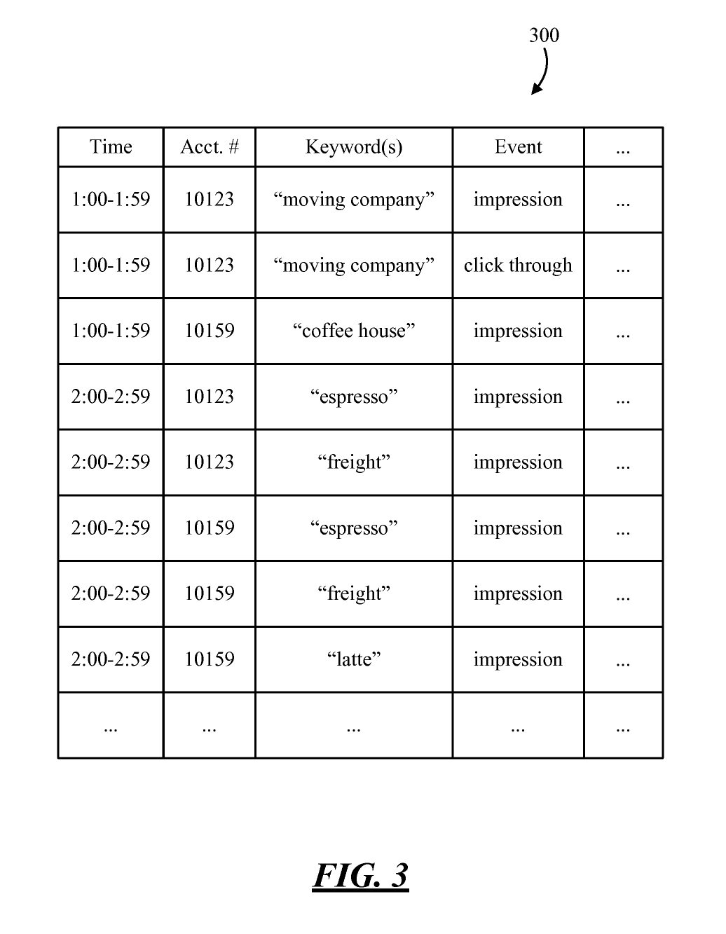

The resulting sorted records may look like the records shown in table 300 of FIG. 3. The example records in FIG. 3 have the attributes “time”, “account number”, “keyword”, and “event”. For example, each of these records might represent a web advertising event. Thus, “time” may be the time slice during which the event occurred, “account number” may be the account number of the customer to which the event relates, “keyword” may be the keywords (e.g., search terms) from which the event stems, and “event” may be the type of event (impression or click through, in this example.)

In the example of FIG. 3, the clustered key comprises the attributes “time”, “account number”, and “keyword”, in that order. Each time slice, in this example, is a one-hour slice ranging from :00 through :59 of some hour. Thus, all records that occur in the time slice 1:00-1:59 are grouped together into a sequential run of records. And all records that occur in the time slice 2:00-2:59 are grouped together in a sequential run of records. And so on. The result is that all records that have the same value for the “time” attribute appear next to each other in a sequence. (For simplicity of illustration, the date has been omitted from this example, although date and time could be combined into a single attribute, in which case a time slice might be denoted “Jan. 1, 2010 1:00-1:59”.)

The records are next sorted on the “account number” attribute. The sort on the account number attribute does not undo the grouping of records by time, but rather groups like values of the “account number” attribute within each grouping by time. Thus, within the 1:00-1:59 group, all of the records relating to account number 10123 appear together in a sequence, and all of the records relating to account number 10159 appear together in a sequence. This grouping by account number is then repeated for records having the “time” value of 2:00-2:59, so that the records for account numbers 10123 and 10159 are grouped together within the 2:00-2:59 time slice.

After sorting the records by the “account number” attribute, the records are next sorted by the “keyword” attribute. Thus, for any given combination of the “time” and “account number” values (e.g., time=2:00-2:59 and account number=10159), like values of the “keyword” attribute are clustered together.

As noted above, one use of a data mart that has been clustered in accordance with the technique of FIG. 2 is to perform an efficient retrieval of records on certain types of requests. FIG. 4 shows an example process of retrieving records in response to a request.

At 402, a request for data is received. A request may be made in any manner, using any type of logic. Query languages, such as SQL, allow users to select portions of a database using arbitrarily complex selection logic. However, one type of request that may be serviced is one that specifies the value of an attribute, or a range of values for an attribute (block 404). If such a request is defined in terms of one of the attributes that makes up the clustered key, then the act of responding to the request may take advantage of the efficiency of sequential reads.

Thus, at 406, data records are retrieved that match the specification of an attribute in the request. For example, if the request seeks records that have a time value in the range 1:00-1:59, then all records having this time value are retrieved. Or, as another example, the request might seek all records in the time range 1:00-3:59, in which case all records having time values of either 1:00-1:59, 2:00-2:59, or 3:00-3:59 would be retrieved (assuming the time-slice labeling scheme shown in FIG. 3). It is noted that the data that is retrieved may be stored sequentially (or in several sequential runs) (block 412). Moreover, the data may be physically stored in a single block, or in some subset of the blocks in which the data mart is stored. One aspect of organizing a data mart according to a clustered key is that doing so may allow the data that is being sought to be retrieved sequentially (or in a small number of sequential runs). Another aspect of organizing a data mart according to a clustered key is that—due to the organization of data into one or more sequential runs—it may be possible to avoid reading all of the blocks of data in which the data mart is stored. Since reading a block may be an expensive operation, the sequential organization of data may allow the system that retrieves data to avoid reading blocks that do not contain the data being sought. In this way, the organization of data in a data mart according to a clustered key uses the physical features of a data storage and retrieval system to achieve an efficiency that otherwise would not be achieved.

At 408, additional filtering criteria may be applied. That is, the process of FIG. 4 may impose additional criteria beyond an attribute having a particular value or falling in a particular range. For example, suppose that—in addition to the attributes shown in FIG. 3—a set of records also has numerical attributes a₁ and a₂, which represent some arbitrary quantities. Then, a user could request those records for which the “account number” value matches 10123, and for which the product of a₁ and a₂ is no more than one hundred. In this case, the condition of a₁a₂<=100 is an example of an additional filtering criterion. Records can be selected that satisfy this additional filtering criterion.

At 410, results based on the request may be provided in a tangible form. For example, results may be communicated to a user, or may be durably, non-transitorily stored in a database or other storage mechanism.

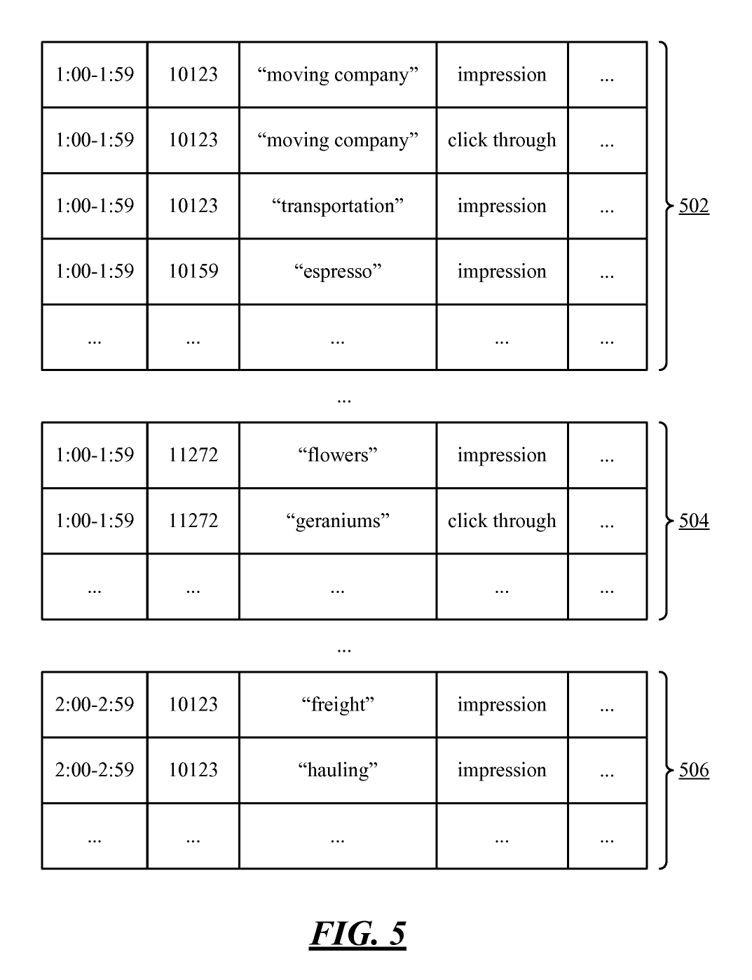

As noted above, the organization of data into one or more sequential runs allows certain efficiencies to be achieved—because sequential reads can be performed more efficiently than random reads, and/or because avoiding reads of some blocks of data avoids the expenditure of resources and time to read those blocks. To illustrate this point, FIG. 5 shows an example data mart that is stored in several physical blocks.

In the example of FIG. 5, it is assumed that a data mart is organized according to a clustered key that contains the time, account number, and keyword attributes in that order. Thus, as in FIG. 3, the entries in the same time slice (e.g., 1:00-1:59) are sequentially clustered together; then, within a given time slice, the entries having the same account number are clustered together; then, within a given time slice and account number combination, the entries having the same keyword(s) are clustered together. In practice, the records that make up the data mart may be stored in several blocks of storage. A block is a unit of storage that a storage device may be designed to read atomically. Thus, as a low-level hardware operation, it may be possible to read a block of data, but not less than a block. In this case, a request for a single record for a block would involve reading the entire block, thereby causing much data to be read that is not relevant to the data that is actually being sought. In this sense, having to read irrelevant data imposes a cost in terms of time and physical resources. Organizing data according to a clustered key may thereby leverage the physical storage retrieval infrastructure by avoiding some reads.

In the example of FIG. 5, three separate blocks of data are shown: blocks 502, 504, and 506. There may be other blocks between blocks 502-506 (as indicated by the ellipses between these blocks), but for simplicity of illustration these other blocks are not shown. As can be seen, the records in the time slice 1:00-1:59 are stored across blocks 502 and 504, but the records in time slice 2:00-2:59 are stored in block 506. Thus, if one requests records in the time slice 1:00-1:59, it is possible to avoid reading block 506, since it can be determined from the sequential organization of the data that, once the last record having a 1:00-1:59 time slice has been read, no subsequent block contains any records in that time slice.

Additionally, it is possible to gain efficiencies when data is requested based on attributes other than time. For example, if one requests records for account number 10123, then the retrieval system can read block 502 to obtain those records. However, since no records in time slice 1:00-1:59 and account number 10123 appear outside of block 502, it is possible to avoid reading block 504. (It is assumed, in this example, that block 504 contains only records for time slice 1:00-1:59; since block 502 contains the last record for account number 10123 in time slice 1:00-1:59, the reading of blocks can be avoided up to the point where the next time slice begins, which, in this example, is block 506.) Since time slice 2:00-2:59 begins in block 506, this block can be read next in order to find records that have account number 10123. Thus, using the second attribute in the clustered key as a search criterion may involve reading more blocks than using the first attribute in the clustered key, but doing so still generates some efficiency relative to performing a random read. It is noted that a similar efficiency could also be achieved if the search is performed on the third (“keyword”) attribute in the clustered key. However, using an attribute that is far from the first attribute in the clustered key indicates that the data being sought will be organized into a greater number of sequential runs, thereby making it likely that a greater number of blocks will have to be read. In other words, the efficiency of the search may decrease the further one's search criteria gets from the first attribute in the clustered key.

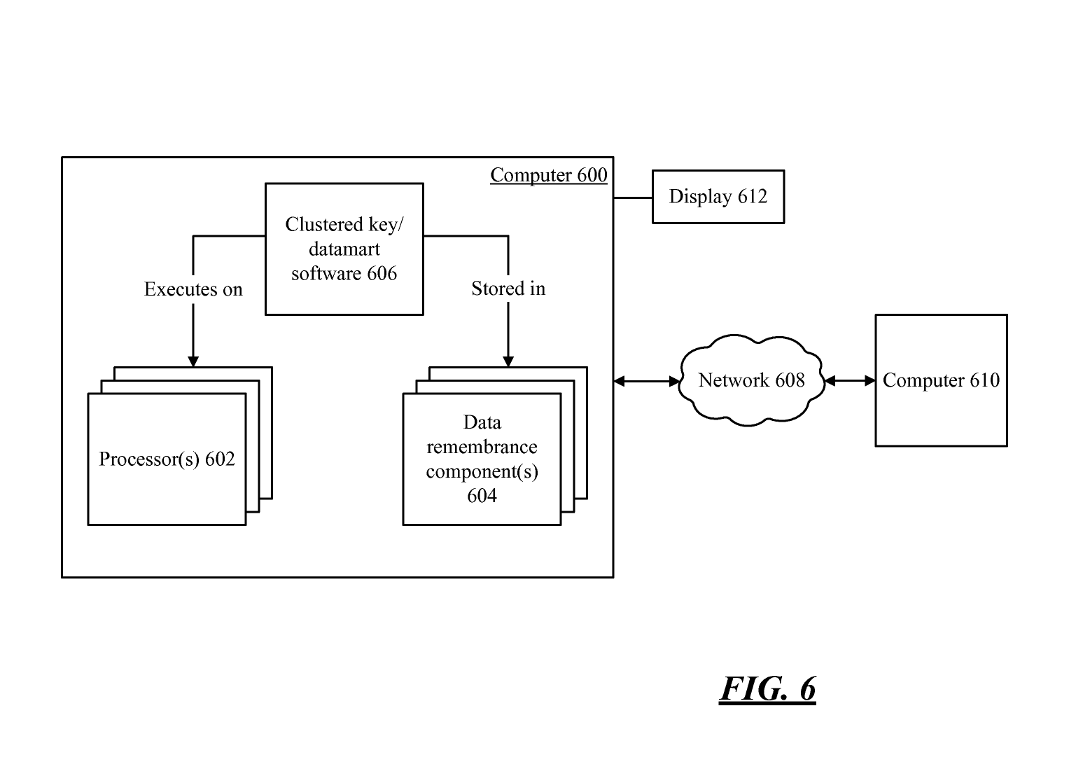

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is clustered key/datamart software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium. It is noted that there is a distinction between media on which signals are “stored” (which may be referred to as “storage media”), and—in contradistinction—media that contain or transmit propagating signals. DVDs, flash memory, magnetic disks, etc., are examples of storage media. On the other hand, wires or fibers in which signals are stored ephemerally are examples of transitory signal media.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

It is noted that, in the claims herein, the term “combination of values” may refer to a combination of specific values for plural attributes, such as attribute a₁=A and attribute a₂=B. However, the term “combination of values” may also refer to the degenerative case in which there is only a single attribute—i.e., attribute a₁=A is an example of a “combination of values” in which the number of values in question happens to be one.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of using data in a data mart, the method comprising:
using a processor to perform acts comprising:
choosing a clustered key that comprises a plurality of attributes in an order;
hierarchically sorting records of said data on each of said attributes in said order;
receiving a request to retrieve the records of said data that have a value in a first one of said attributes, or that fall in a range of values in said first one of said attributes;
retrieving only physical blocks of said data mart that contain records that have said value in said first one of said attributes or that contain records falling in said range of values in said first one of said attributes, the blocks that are retrieved being retrieved blocks; and
providing results based on said retrieved blocks.

2. The method of claim 1, further comprising:
receiving raw data; and
creating said data mart based on said raw data.

3. The method of claim 1, wherein each of said physical blocks is a unit that is atomically readable by a physical storage device on which said blocks are stored, wherein no unit smaller than one of said physical blocks is atomically readable by said physical storage device.

4. The method of claim 1, wherein said records describe web advertising events.

5. The method of claim 1, wherein said data mart is organized such that all of said records having a particular value in a second one of said attributes that appears first in said order are in a single sequential run of records.

6. The method of claim 1, wherein said data mart is organized such that all of said records having a particular value in a second one of said attributes that appears second or subsequently in said order has one sequential run for each combination of values of attributes that appear prior, in said order, to said second one of said attributes.

7. The method of claim 1, further comprising:
applying, to said retrieved blocks, a filtering criterion other than whether a record has an attribute that has a particular value or falls within a range of values;
wherein said results comprise those records that, for said first one of said attributes, either have said value or that fall within said range of values, and that satisfy said filtering criterion.

8. The method of claim 1, wherein said choosing of said clustered key comprises:
determining, based on historical request patterns, which attributes are frequently used as request criteria, and in which order of frequency, wherein attributes in said clustered key, and the order in which attributes appear in said clustered key, are chosen based on which attributes are frequently used as request criteria and based on order of frequency.

9. One or more computer-readable storage media that store a data mart, wherein said data mart comprises:
a plurality of records, each of said records having a plurality of attributes, said records being hierarchically sorted according to a clustered key that comprises a set of said attributes in an order, wherein said plurality of records are stored in a plurality of blocks on said one or more computer-readable storage media, wherein said one or more computer-readable storage media are readable by a device, wherein each of said plurality of blocks is atomically readable by said device and no unit smaller than a block is atomically readable by said device,
wherein records that have a first value in a first one of said set of attributes are in a single sequential run of said records, and wherein records that have a second value in a second one of said set of attributes are in one sequential run of records for each combination of values for all attributes that appear prior, in said order, to said first one of said set of attributes, wherein said first one of said set of attributes is first in said order, and wherein said second one of said set of attributes is subsequent, in said order, to said first one of said set of attributes.

10. The one or more computer-readable storage media of claim 9, wherein said data mart comprises a plurality of web advertising events.

11. The one or more computer-readable storage media of claim 9, wherein said clustered key comprises attributes that, based on historical analysis of requests, are determined to have been used frequently as a basis for requests, and wherein said order is based on frequencies in which the plurality of attributes in said clustered key historically have been used.

12. A system for using data in a data mart, the system comprising:
a memory, in which atomically readable physical blocks of said data mart are stored;
a processor; and
a component that is stored in said memory and that executes on said processor, wherein said component chooses a clustered key that comprises a plurality of attributes in an order, wherein said component hierarchically sorts records of said data on each of said attributes in said order, wherein said component receives a request to retrieve the records of said data that have a value in a first one of said attributes or that fall in a range of values in said first one of said attributes, wherein said component retrieves, from said memory, only physical blocks of said data mart that contain records that have said value in said first one of said attributes or that contain records falling in said range of values in said first one of said attributes, the blocks that are retrieved being retrieved blocks, and wherein said component provides results based on said retrieved blocks.

13. The system of claim 12, wherein said first one of said attributes appears first in said order, and wherein each value in said first one of said attributes comprises a time range during which web advertising events have occurred.

14. The system of claim 12, wherein said component receives raw data, and creates said data mart based on said raw data.

15. The system of claim 12, wherein each of said physical blocks is a unit that is atomically readable from said memory, wherein no unit smaller than one of said physical blocks is atomically readable from said memory.

16. The system of claim 12, wherein said records describe web advertising events.

17. The system of claim 12, wherein said data mart is organized such that all of said records having a particular value in a second one of said attributes that appears first in said order are in a single sequential run of records.

18. The system of claim 12, wherein said data mart is organized in said memory such that all of said records having a particular value in a second one of said attributes that appears second or subsequently in said order has one sequential run for each combination of values of attributes that appear prior, in said order, to said second one of said attributes.

19. The system of claim 12, wherein said component applies, to said retrieved blocks, a filtering criterion other than whether a record has an attribute that has a particular value or falls within a range of values, and wherein said results comprise those records that, for said first one of said attributes, either have said value or that fall within said range of values, and that satisfy said filtering criterion.

20. The system of claim 12, wherein said component, to choose said clustered key, determines based on historical request patterns which attributes are frequently used as request criteria, and in which order of frequency, wherein attributes in said clustered key, and the order in which attributes appear in said clustered key, are chosen based on which attributes are frequently used as request criteria and based on order of frequency.
